(19) United States
(12) Patent Application Publication
(10) Pub. No.: US 2004/0152061 A1
(43) Pub. Date: Aug. 5, 2004

(54) Methods of an apparatus for training children to avoid dangerous situations

(76) Inventor: Thomas J. Patire, Elmwood Park, NJ (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/748,214

(22) Filed: Dec. 31, 2003

Related U.S. Application Data
(63) Continuation-in-part of application No. 10/713,766, filed on Nov. 17, 2003.
(60) Provisional application No. 60/426,381, filed on Nov. 15, 2002.

(51) Int. Cl. G09B 19/00; G09B 5/00

(52) U.S. Cl. 434/308; 434/238

(57) ABSTRACT

Methods of and apparatus for child safety training include a CD having sound segments at spaced intervals thereon, wherein each sound segment is indicative of a hazardous condition such as, but not limited to, a braking car, an approaching train, a barking dog, and/or any other sound which is associated with a dangerous situation. Groups of children are taught to recognize and identify the sounds indicating danger and are then required to run an obstacle course while the CD is being played. The segments are spaced to give the children a chance to run the course. When a segment is played, the children are trained to stop running and how to specifically respond to a danger by moving away from the danger in a particular way and scanning the area in order to further understand the danger.

### RELATED APPLICATIONS

This application is a continuation-in-part of patent application Ser. No. 10/713,766, filed Nov. 17, 2003, which claims priority from provisional patent application No. 60/426,381, filed Nov. 15, 2002.

### FIELD OF THE INVENTION

The present invention is directed to methods of and apparatus for training children to avoid dangerous situations. More particularly, the present invention is directed to such methods and apparatus which utilize sound recognition and muscle memory to provide children with a reflexive avoidance response to hazardous situations.

### BACKGROUND OF THE INVENTION

Modern societies have situations which are dangerous to children, some of which are relatively new. Over millenniums, humans as well as other creatures, have developed avoidance responses to perceived hazardous situations, which responses are reflexive in that they require either no thought at all or minimal thought resulting in responses that are substantially immediate. We look in the direction of a loud noise, duck out of the way of a thrown object or withdraw upon touching something painful. While many of these responses are deemed instinctive, similar responses are learned when training for athletic contests so that the athlete does not have to think as to an appropriate response to a particular situation.

Modern life has a number of hazards that are of particular danger to children, frequently causing injury and sometimes death. These hazards are public health problems; a number of which did not exist several generations ago. While vicious dogs and panic stricken crowds, as well as dangerous strangers have been problems for hundreds, if not thousands of years, broken glass, automobiles, police and fire vehicles and trains are relatively recent phenomenon. While these instrumentalities are equipped with warning devices such as horns and alarms, there is no instinctive behavior which specifically addresses a proper response for a child. In order to reduce the number of injuries and deaths to children in a modern society, children need to possess skills which cause them to instantly recognize and avoid dangers poised by these hazards.

### SUMMARY OF THE INVENTION

In view of the aforementioned considerations, the present invention is directed to a method of training children to avoid hazards wherein the method comprises teaching a group of children sounds of hazardous conditions by playing a recording having a series of sound segments, wherein each sound segment includes sounds of a distinct hazardous condition and each sound segment is separated from proceeding and following sound segments by a time interval. In accordance with the invention, the children traverse an obstacle course with obstacles spaced from one another by distance intervals sufficient to allow the children an opportunity to run over a portion of the course prior to the next sound segment. Upon the children hearing a sound segment, the children immediately stop and perform a hazard avoidance response designed specifically for each hazardous condition. After performing the hazard avoidance response, the children again run until the next sound segment is played. The method steps of running the obstacle course, stopping upon hearing the hazardous sound segment and reacting appropriately thereto, and then running until a subsequent hazardous sound segment is played is repeated until the children have developed appropriate hazard avoidance responses to specific sound patterns indicative of specific hazardous conditions.

In one aspect of the method, the children are taught the names of the hazardous conditions in conjunction with hearing the sounds of the hazardous conditions before running on the obstacle course.

In a more specific aspect of the method, the hazardous conditions on the Sound recording include sounds comprising:

breaking or broken glass;

a braking automobile;

a panic stricken crowd;

a vicious dog barking;

police/fire vehicles in motion;

a smoke detector alarm;

a train in motion, and

friendly voice from a stranger asking for help.

In still another aspect of the method, the recording has a first sound track for teaching the children the names of the sounds indicative of hazardous conditions wherein the time intervals between the segments are of a first duration, and has a second track wherein the time intervals are sufficient to allow children to run a portion of the obstacle course between playing the sound segments.

In still a further aspect of the method, the time intervals of the first track are about five seconds and the tine intervals of the second track are about ten seconds.

In accordance with another aspect of the method, additional sound tracks are played having hazardous sound segments arranged in orders which differ from one another.

In another aspect of the method, the sound of a ringing bell initiates teaching of the responses to the sounds indicative of hazardous conditions.

The invention further includes apparatus for child safety training wherein the apparatus comprises an obstacle course for traversal by children, the obstacle course having obstacles thereon at spaced locations for children to negotiate as they proceed along the course. A sound recording is provided in association with the obstacle course wherein the sound recording has sound segments, each of which is indicative of a hazardous condition, the sound segments being separated by tine intervals and the tine intervals being of a duration sufficient for a child to advance over a portion of the obstacle course. The apparatus includes instructions associated with each hazardous condition for informing a child as to an effective response to the hazardous condition.

In a further aspect of the apparatus, the sound recording includes first and second training tracks, the first training track training children to identify and name sounds of the hazardous conditions and the second training track being used in conjunction with the obstacle course.

In a further aspect of the apparatus, the time intervals between the segments of the first training track are about five seconds and the time intervals between the segments of the second training track are about ten seconds.

In still another aspect of the apparatus, there are additional sound tracks having hazardous sound segments occurring in different orders.

### BRIEF DESCRIPTIONS OF THE INVENTION

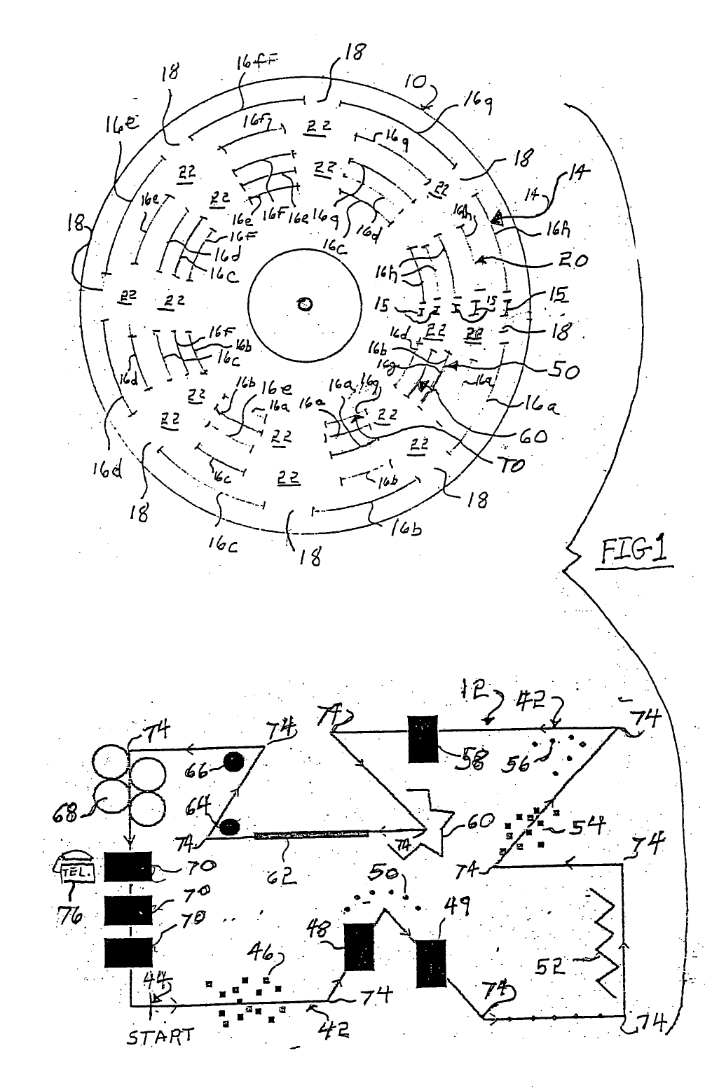

FIG. 1 is a schematic view of the apparatus for practicing the method of the present invention, which apparatus includes a disc with sound tracks thereon and an obstacle course;

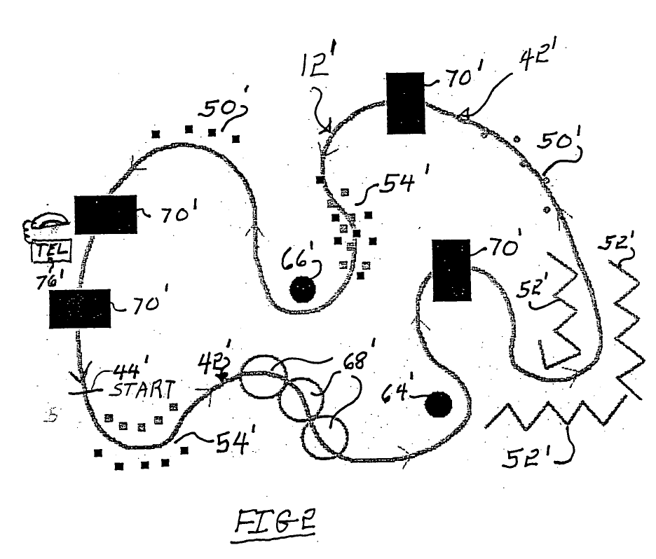

FIG. 2 is a second embodiment of an obstacle course according to the present invention used to practice the method of the present invention; and

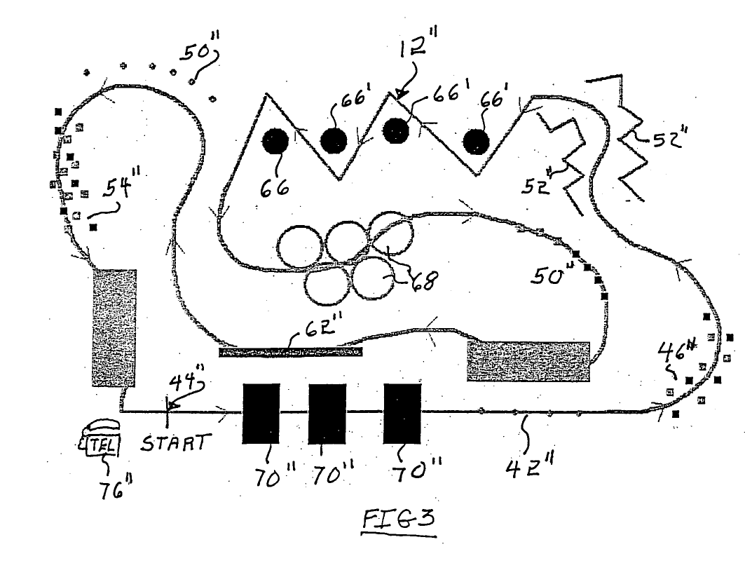

FIG. 3 is a third embodiment of an obstacle course in accordance with the present invention used to practice the method of the invention.

Referring now to FIG. 1, there is shown a CD 10 (compact disc) with schematically illustrated sound tracks configured in accordance with the principles of the present invention, which is used as part of an apparatus for practicing the method of the present invention. The CD 10 is used in association with an obstacle course 12 in order to teach children appropriate responses to sounds indicative of hazardous conditions. As will be further explained, the apparatus of the present invention uses sound recognition provided by playing the CD 10 to children and muscle memory taught by running and intermittently stopping on the obstacle course 12 to instill good reactions to the occurrence of bad sounds indicative of dangerous conditions.

The CD 10 schematically illustrates a first sound track 14 having a starting sound segment 15 followed by dangerous sound segments 16a, b, c, d, e, f, g and h separated by time intervals 18, schematically shown enlarged on a portion of the disc 10. The sound segments 16a-h in accordance with one embodiment include breaking or broken glass 16a, a car screeching to a halt 16b, a panic stricken crowd 16c, a vicious dog barking 16d, police/fire vehicles in motion 16e, a smoke detector alarm 16f, a train in motion 16g and a friendly voice asking for help 16h. In the first track 12 of the CD 10, the spaces between the hazardous sound segments 16a-16h are each separated by a five second interval 18. The five second interval provides an instructor sufficient time to state the name of the hazard and have the children repeat the name. If necessary, the CD 10 can be stopped in order to discuss the hazard and make sure the children understand its nature. The next sound hazard segment 16b is then played and followed by a five second interval during which the children are taught the name of the hazard. This is continued until each of the hazards has been named and perhaps discussed. The first sound track 14 can then be repeated with the children naming the hazard either individually or as a group until the hazard is readily identified by the children.

Prior to the sound identification exercise using the first sound track 14, the initial sound segment 15, which is a ringing bell, is played to start the sequence of hazardous sound with an explanation to the children that the starting bell has no meaning except to start the obstacle course. Sound track 14 is for “sound identification.”

After the children are able to name the hazards associated with the specific sounds 16a-16h, the instruction then progresses to the second sound track 20, which has the hazardous sound segments 16a-16h separated in time from one another by a minimum 10 second time interval 22 during which each sound is named while the appropriate safe movement is demonstrated by the instructor. After the moves are taught, then the children are led over obstacle course such as the obstacle course 12 of FIG. 1 as the disc 10 is played. Preferably, the children play follow the leader and follow the instructor over a path 42 through a series of obstacles upon starting at a location 44 upon hearing the starting bell on the second track of the recording on disc 10.

The children then begin negotiating the obstacles on the obstacle course 12 which, for example, include an array of small blocks 46 followed by larger blocks 48 and 49 between which a line of cones 50 is positioned. Typically, the children will weave in shalom fashion through the cones 50. The path 42 then passes an unfolded partition 52 and another array of blocks 54 which the children step over to avoid. A series of cones 56 is then provided through which the children weave before passing another relatively large block 58. A folded partition 60 is positioned in front of a vertical wall 62 and the vertical wall 62 is followed by pillars 64 and 66 around which the children maneuver. The children then proceed through an array of circular members 68 and then over an array of pads 70 before arriving back at the starting line 44. The path 42 has a number of directional changes at corners 74. As the children traverse the obstacle course 12 along the path 42, their attention is constantly focused on the various obstacles and on changing directions so that they remain on the path. The obstacle course 40 replicates play and the children enjoy running over it. Most children who have not taken the safety training course which is the subject of this patent application, will continue to run around the track and ignore the dangerous sounds on the disc 10. The purpose of the invention is to get children to recognize these dangerous sounds and react with avoidance so they can avoid dangerous conditions.

FIGS. 2 and 3 illustrate other obstacle courses 12′ and 12″! which have obstacles with numerals thereon primed. Obstacle courses of any safe configuration, which allow children to run and stop and which are compatible with the sound segments on CD10 are suitable for practicing the methods and apparatus of this invention.

At least initially, the sound segments 16a-16h follow a fixed order in a series. For example, the first sound segment 16a is broken glass which occurs ten seconds after the start bell. By this time, the children have learned that broken glass can cause serious injuries by walking on it or grabbing it. They know that it is to be avoided. The response to the sound of broken glass under foot is to stop, freeze and scan in order to determine the location of the glass. Once the children know the location of the glass, they will know how to avoid it by backing up or proceeding cautiously to avoid the location of the glass. Ten seconds after hearing the sound of broken glass, the CD plays the hazardous sound segment 16b of a car screeching to a halt. The children now know that motor vehicle drivers sometimes accidentally lose control of their vehicles or don't pay attention to the road, just like children that run into the street without looking. The appropriate response to this hazard is to immediately stop, jump back, turn and run five steps then stop and scan. It makes no difference where a child is on the path 42 through obstacle course 12 when either of these hazardous sounds occur. If the children are playing follow the leader, then some children will be close to the instructor and other children will be further back from the instructor. The sounds therefore occur at random locations of the children on the path 42. If the children are running the obstacle course 12 as individuals, some children will be faster than others and therefore one child may be at a location on the path 42 that is different from another child. It is only important that the children learn specific sounds that will distract them from their normal activities when heard, and that the children will respond with a safe, proper avoidance movement that corresponds to the hazardous sound.

Ten seconds after the sound of a car screeching to a halt occurs, there is the sound segment 16c of panic stricken crowd. The children know that crowds at sporting events or amusement parks are frequently in such a rush to get in or leave that the crowds accidentally trample children because they don't see them in time to stop. The children have been taught that the proper response is to locate the nearest obstacle or parent and grab onto it. If the child is alone, the child yells, “help, help, child here” in order to get people to notice them. Ten seconds later, the tape plays the sound segment 16d of a vicious dog barking. The children have learned that in many cases dogs bite because quick motions startle or agitate them. Accordingly, the children make an immediate stop and remain motionless until the barking ceases, at which time they slowly retreat.

Some sounds indicating danger are generated by the source of danger itself such as the sirens of police/fire vehicles, smoke detector alarms and horns or whistles from trains. Ten seconds after the vicious dog barking sound segment 16d, a siren sound segment 16e indicative of police/fire vehicles in motion occurs. The children know that when an emergency vehicle is in route to aid someone, these vehicles often use excessive speed which makes such vehicles harder to stop and harder to control. Children are curious as to where these vehicles are going or are intrigued by seeing the flashing lights. This can cause the child to run out into the street or to stay close to the curb to watch. The proper response to this sound is to immediately stop, turn around and run back at least five steps, and then turn around and look. Ten seconds after the police/fire vehicle siren, a smoke detector alarm segment 16f sounds. The children have learned that smoke inhalation disrupts vision and breathing and can lead to immediate panic in children. The proper response is to drop down near the floor and crawl underneath the smoke along the nearest fixed object like a wall and then yell “mommy, daddy, I am in the room next to the wall.” On each of the obstacle courses 12, 12′, 12″ of FIGS. 1-3 a wall 62 is included. Wherever the children are on the path 42 of the obstacle course, they crawl toward and then briefly along the wall 62 so that they are likely to crawl pass or over other obstacles just as they would in a house.

Trains in motion provide a hazardous sound segment 16g ten seconds after the smoke detector alarm segment 16f. A train engineer will usually spot a child on a train track and sound his whistle or horn warning the child to get out of the way. The children have already learned that train sounds echo so that in certain situations, the noise sounds further away than it really is, giving a child a false sense of security when standing on or near train tracks. The appropriate response is to immediately stop, turn around and run at least five steps and then scan.

Ten seconds after the train in motion segment 16g, the disc plays the sound segment 16h of a friendly stranger asking for help. The children have learned that friendly people with friendly voices get children to drop their guard so that they can then be led astray. Statements to similar to “Hi, I am a friend of your mom and dad's. They said you should come with and help me find my puppy.” The proper physical response is to back up, run and yell “Don't touch me, stranger, stranger!” The child then runs back the same way he or she came. If possible, the child then runs to a telephone 76 at a known location near or on the obstacle course 12 and dials 911. The child then says his or her name and gives his or her address and states “I need help!” Running the obstacle course ends with the telephone call.

The children then run the obstacle course 12 while the CD 10 plays the second track 20, starting with the bell sound segment 15, stopping at ten second intervals in response to hazardous sounds and physically reacting to avoid the danger conveyed by the individual sound segments. The children then practice the appropriate reactions until those reactions are learned.

The time intervals 22 between the hazardous sound segments 16a-16h may be quiet with no sound or may have background sounds such as traffic or children playing. The background sounds may continue through the segments 16a-16h to provide a more realistic sound track 14 or may stop.

In the real world, hazardous sounds do not occur in any particular order and seldom occur accompanied by other hazardous Sounds. In order to train for this, it is preferable that at least three additional tracks are provided on the CD. On a third track 50, the order of hazardous sound segments may be:

car screeching to a halt 16b;

broken glass 16a;

police/fire vehicles in motion 16e;

panic stricken crowd 16c;

vicious dog barking 16d;

smoke detector alarm 16f;

train in motion 16g; and

friendly voice asking for help 16h.

The final activity at the end of the third track is to “run to phone—dial 911—‘my name is ______’, I live at ______, I need help!” On a fourth track 60, the sounds have still another order after the bell rings at segment 15 starting the child to run over the path 42 through the obstacle course 40. The order of sounds in the fourth track 50 are:

train in motion 16g;

broken glass 16a;

car screeching to a halt 16b;

smoke detector alarm 16f;

panic stricken crowd 16c;

police/fire vehicles in motion 16e;

vicious dog barking 16d; and

friendly voice asking for help 16h.

Again, at the end of sound track 4, the child runs to a phone, dials 911 and states “my name is ______, I live at ______, I need help!”

A fifth track 70 is also provided on the disc 10. In the fifth track after the starting bell rings, the hazardous sounds of the following order:

vicious dog barking 16d;

train in motion 16g;

broken glass 16a;

car screeching to a halt 16b;

smoke detector alarm 16f;

police/fire vehicles in motion 16e;

panic stricken crowd 16c; and

friendly voice asking for help 16h.

The child is then again instructed to run to the phone, dial 911 and state “my name is ______, I live at ______, I need help!” Each track ends with running to a phone, dialing 911 and recitation of the child's name and address plus the statement “I need help!” The hazardous sound segments 16a-16b may have any order in a track and even more than five tracks may be used. The sound tracks used may have fewer or more hazardous sound segments than those discussed and illustrated in this disclosure. Additional sounds may be added to the track such as, but not limited to, an approaching motorcycle or even gunshots. It is preferable that each track end with the child running to a phone, dialing “911,” stating their name and address and stating “I need help!” Since children learn at different rates, some children may need more exposure to the obstacle course 12 and sound tracks than others and may need additional prompting.

A final step in this program is once all children have completed the safety course, they are called up one at a time with their parents or guardians present and presented with their NO AND GO™ certificate of safety while their parents are presented with a NO AND GO™ parental safety manual. After every child has received their certificate, a photo is taken to post in the facility to start a NO AND GO™ child safety bulletin board which keeps parents and children updated on the next NO AND GO™ course. Everyone is then congratulated and again reminded to “be safe!!!!”

The preferable way to expose as many children as possible to this safety program is to distribute the program as a franchised business to businesses which train children in activities such as karate and other martial arts. This is accomplished by first having a franchisee download an advertisement from the franchising company from a secured section of the originating companies website. The date, time, place, fee and age group of the course to be presented at a location is then placed on the advertisement. The course is then discussed at classes on the site and the ad is posted with a sign up sheet for parents. A promotional video is then played at the site to familiarize parents with the safety course. Since the safety course is for the benefit of minor children, it is highly preferred that the business presenting the safety course to its clientele as well as the instructors involved in the safety course, present the franchisee of the concept with executed affidavits from the business and the instructors stating that they have no criminal record or civil record which would adversely reflect on the advisability of them interacting with children.

Once parents have signed up their children, a typed list of the children's names only is taxed to the originating company with the way that the parents want the names printed on a certificate presented at the completion of the course. All of the children's certificates are processed together and then mailed to the franchisee in time for the course.

From the foregoing description, one skilled in the art can easily ascertain the essential characteristics of this invention, and without departing form the spirit and scope thereof, can make various changes and modifications of the invention to adapt it to various usages and conditions.

1. A method of training children to avoid hazards, comprising:
a) teaching a group of children sounds of hazardous conditions by playing a recording having a series Of sound segments wherein each sound segment has the sounds of a distinct hazardous condition and each sound segment is separated from proceeding and following sound segments by a time interval;
b) while playing the recording having the children traverse an obstacle course of sufficient length to allow the children an opportunity to run a reasonable distance before and prior to playing each sound track segment;
c) upon each sound segment playing, having the children perform hazard avoidance responses designed specifically for the hazardous condition of that sound segment; and
d) repeating a)-d) until the children have developed appropriate hazard avoidance responses specific to sound patterns indicative of specific hazardous conditions.

2. The method of claim 1, wherein teaching the children includes teaching the children the names of the hazardous conditions in conjunction with the children hearing the sounds of the hazardous conditions.

3. The method of claim 2, wherein the hazardous sounds of the hazardous conditions comprise:
breaking or broken glass;
a braking automobile;
a panic stricken crowd;
a vicious dog barking;
police/fire vehicles in motion;
a smoke detector alarm;
a train in motion, and
a friendly voice from a stranger asking for help.

4. The method of claim 3, wherein the recording has a first sound track for teaching the children the names of the sounds indicative of hazardous conditions wherein the time intervals between the segments is of a first duration and wherein the sound recording has a second track with time intervals of a duration longer than the first duration.

5. The method of claim 4, wherein the time intervals of the first track are about 5 seconds and the time intervals of the second track are about 10 seconds.

6. The method of claim 2, wherein there are additional sound tracks having the hazardous sound segments played in orders which differ from one another.

7. The method of claim 2, further including leading the children through the obstacle course for at least one cycle with an instructor who demonstrates effective active responses to each hazardous condition in response to hearing sounds indicative of the hazard.

8. The method of claim 2 wherein the second track has a final sound segment in which the children each dial an emergency number as part of their hazard avoidance response.

9. Apparatus for child safety training, comprising:
an obstacle course for traversal by children, the obstacle course having obstacles thereon at spaced locations for children to negotiate as they proceed along the course;
a sound recording associated with the obstacle course, the sound recording having sound segments each of which is indicative of a hazardous condition, wherein each segment is separated from prior and subsequent segments by time intervals, the time intervals being of a duration sufficient for a child to advance over a portion of the course, and
instructions associated with each hazardous condition for informing a child as to an effective response to the hazardous condition.

10. The apparatus of claim 9, wherein the sound recording includes first and second training tracks, the first raining track training children to identify sounds of the hazardous conditions by name and the second training track being used in conjunction with the obstacle course and having only sounds indicative of specific hazards, the specific hazards being spaced by time intervals on the second sound track.

11. The apparatus of claim 10, wherein the hazardous conditions on the sound recording include sounds comprising:
breaking or broken glass;
braking automobile;
panic stricken crowd;
vicious dog barking;
police/fire vehicles in motion;
smoke detector alarm;
a train in motion, and
a friendly voice from stranger asking for help.

12. The apparatus of claim 11, wherein the tine intervals between segments of the first training track are about 5 seconds.

13. The apparatus of claim 12, wherein the time intervals between segments of the second training track are about 10 seconds.

14. The apparatus of claim 10, wherein the time intervals between segments of the first training track are about 5 seconds.

15. The apparatus of claim 14, wherein the time intervals between segments of the second training track are about 10 seconds.

16. The apparatus of claim 10, wherein the time intervals between segments of the second training track are about 10 seconds.

17. The apparatus of claim 10, wherein each of the tracks includes the sound of a ringing bell to initiate teaching of responses to the sounds indicative of hazardous conditions.

18. The apparatus of claim 10, wherein a telephone is part of or adjacent to the obstacle course for the children to telephone an emergency number.
